(19) United States
(12) Patent Application Publication
(10) Pub. No.: US 2009/0303736 A1
(43) Pub. Date: Dec. 10, 2009

(54) Heat-dissipation gain structure of matrix LED light

(76) Inventor: Hsu-Li Yen, Hsin Chuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/155,568

(22) Filed: Jun. 6, 2008

(51) Int. Cl. F21V 29/00

(52) U.S. Cl. 362/373

(57) ABSTRACT

A heat-dissipation gain structure of a matrix LED light includes a metal heat-dissipation unit coupled to a matrix LED light chip, and a metal seat housing, so as to provide rapid heat dissipation and thereby maintain a low temperature. The metal seat housing has a plurality of vent holes for air to pass through and circulate between the metal seat housing, the matrix LED light chip and the metal heat-dissipation unit. Thus, the metal heat-dissipation unit can absorb and rapidly dissipate heat generated by the matrix LED light chip, allowing the matrix LED light chip to remain at a low temperature, preventing the matrix LED light chip from premature aging, and thereby increasing its service life.

### BACKGROUND OF THE INVENTION

1. Technical Field

The present invention relates to a heat-dissipation gain structure of a matrix LED light, and more particularly, to the design of a heat-dissipation structure of a matrix LED light.

2. Description of Related Art

Nowadays, various kinds of lamps are used to bring light to our living space. The lamps can be placed at desired locations to change the brightness of the space with the light they emit. As essential illumination devices in our daily life, the lamps not only help enhance the quality of our living space, but are also closely related to our physical health, especially the eyes.

Generally, basic lighting is necessary to provide sufficient illumination for good vision. Therefore, the stability of illumination light has direct impact on the health of the eyes. Besides, public attention has been drawn to environmental protection issues associated with the raw materials, production and recycling of lamps, and their high power consumption during illumination.

Recently, there is negative news coverage worldwide about the effects of traditional lamps on human bodies and the environment, and it has been a global trend to replace traditional lamps with matrix LED light chips which cause neither environmental protection problems nor damage to human health. Particularly, the matrix LED light chips are power-efficient, provide brighter and more stable illumination than the traditional lamps, and are therefore qualified as excellent lighting devices.

However, heat is generated when a matrix LED light chip emits light. Therefore, when a matrix LED light chip is combined with a lamp seat, a lamp cover, etc. to form a lamp, the matrix LED light chip may undergo premature aging and expire faster than it should if the heat cannot be dissipated effectively.

In order to solve the heat dissipation problem of matrix LED light chips, the inventor of the present invention took pains in finding a way to improve heat dissipation and lower the temperature of matrix LED light chips. After repeated research and experiments, the present inventor finally succeeded in developing a structural design that allows a matrix LED light chip to remain at a low temperature.

### SUMMARY OF THE INVENTION

Therefore, it is an objective of the present invention to provide a heat-dissipation gain structure of a matrix LED light, wherein the heat-dissipation gain structure comprises a metal heat-dissipation unit coupled to a matrix LED light chip, and a metal seat housing, so as to provide rapid heat dissipation and thereby maintain a low temperature. The metal seat housing has a plurality of vent holes for air to pass through and circulate between the metal seat housing, the matrix LED light chip and the metal heat-dissipation unit. Thus, the metal heat-dissipation unit can absorb and rapidly dissipate heat generated by the matrix LED light chip, allowing the matrix LED light chip to remain at a low temperature, preventing the matrix LED light chip from premature aging, and thereby increasing its service life.

To achieve this end, the present invention provides a heat-dissipation gain structure of a matrix LED light, wherein a metal heat-dissipation unit has an upper surface in contact with a lower surface of a matrix LED light chip so as to absorb heat generated by the matrix LED light chip. In addition, the metal heat-dissipation unit has a lower portion coupled to a metal seat housing, so that the heat absorbed by the metal heat-dissipation unit can be conducted to the metal seat housing, which is formed with vent holes to allow air to pass through and circulate between the metal seat housing, the metal heat-dissipation unit and the matrix LED light chip, thereby achieving rapid heat dissipation. Thus, the matrix LED light chip is allowed to remain at a low temperature and have a longer service life.

### BRIEF DESCRIPTION OF THE DRAWINGS

The invention as well as a preferred mode of use, further objectives and advantages thereof will best be understood by reference to the following detailed description of an illustrative embodiment when read in conjunction with the accompanying drawings, wherein:

FIG. 1 is an exploded perspective view of a heat-dissipation gain structure of a matrix LED light according to the present invention;

FIG. 2 is a perspective view of the heat-dissipation gain structure of the matrix LED light according to the present invention;

FIG. 3 is a perspective view of a metal seat housing of the heat-dissipation gain structure of the matrix LED light according to the present invention;

FIG. 4 is another perspective view of the metal seat housing of the heat-dissipation gain structure of the matrix LED light according to the present invention; and

FIG. 5 is a cross-sectional view of the heat-dissipation gain structure of the matrix LED light according to the present invention.

### DETAILED DESCRIPTION OF THE EMBODIMENT

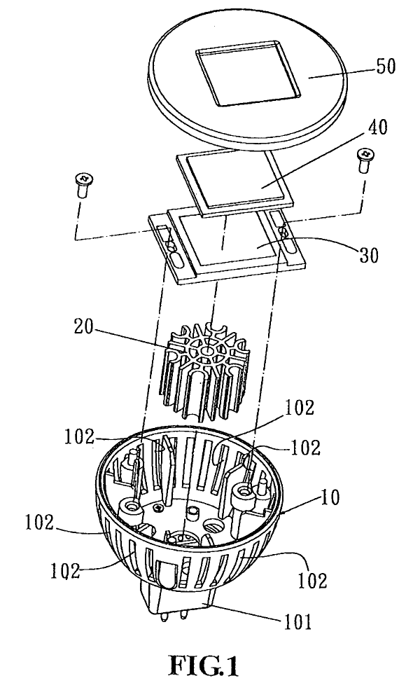

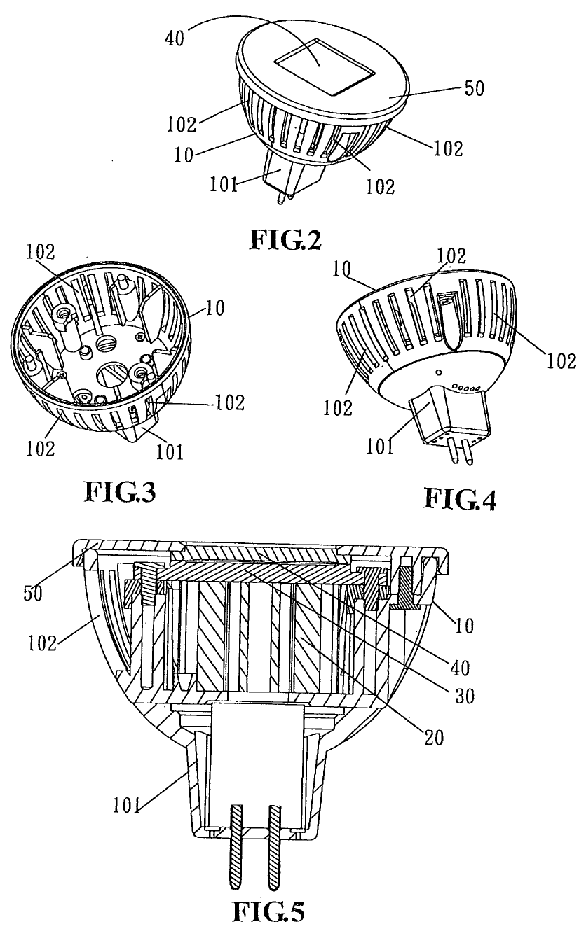

FIG. 1 is an exploded perspective view of a heat-dissipation gain structure of a matrix LED light according to the present invention, wherein the heat-dissipation gain structure comprises a metal seat housing 10 formed with a connector 101, a metal heat-dissipation unit 20, a matrix LED light chip 30, a transparent shield 40, and a cover 50 coupled to one another so as to form the matrix LED lamp, as shown in FIG. 2.

The metal heat-dissipation unit 20 can have a variety of configurations and is composed mainly of a plurality of plate-like elements to accelerate heat dissipation. The metal heat-dissipation unit 20 has an upper surface in contact with a lower surface of the matrix LED light chip 30, and a lower portion coupled to the metal seat housing 10, as shown in FIG. 5. The metal seat housing 10 has a plurality of vent holes 102 for allowing air to enter, circulate in, and exit the metal seat housing 10, as shown in FIGS. 3 and 4.

FIG. 5 is a cross-sectional view of the heat-dissipation gain structure of the matrix LED light according to the present invention. As shown in the drawing, the matrix LED light chip 30 is secured in position to screw posts formed on the metal seat housing 10, so that the lower surface of the matrix LED light chip 30 is in contact with the upper surface of the metal heat-dissipation unit 20. The lower portion of metal heat-dissipation unit 20 is coupled to a lower portion of the metal seat housing 10. Heat generated by the matrix LED light chip 30 during illumination can be absorbed by the metal heat-dissipation unit 20 and then conducted to the metal seat housing 10. As the vent holes 102 of the metal seat housing 10 allow air to circulate between the matrix LED light chip 30, the metal heat-dissipation unit 20 and the metal seat housing 10, heat dissipation is accelerated to keep the matrix LED light chip 30 at a low temperature. Thus, the matrix LED light chip 30 is prevented from premature aging and allowed to have a longer service life.

In conclusion, the heat-dissipation gain structure of the present invention not only provides the intended cooling effect, but also shows non-obviousness. Moreover, the present invention has not been put to public use and meets the requirements of utility and novelty for patent application. Hence, an application for patent of the present invention is hereby filed for examination.

The present invention has been described with a preferred embodiment thereof and it is understood that the embodiment is not intended to limit the scope of the present invention. Therefore, all equivalent changes or modifications which are based on the concept of the present invention and whose functions and effects do not depart from the spirit of the present invention as disclosed herein are encompassed by the appended claims.

What is claimed is:

1. A heat-dissipation gain structure of a matrix LED light, comprising a metal seat housing formed with a connector, a metal heat-dissipation unit, a matrix LED light chip, a transparent shield, and a cover coupled to one another so as to form the matrix LED light, the heat-dissipation gain structure being characterized in that:
the metal heat-dissipation unit comprises a plurality of plate-like elements, an upper surface in contact with a lower surface of the matrix LED light chip, and a lower portion coupled to the metal seat housing; and
the metal seat housing has a plurality of vent holes for allowing air to enter, circulate in, and exit the metal seat housing.
